(19) United States
(12) Patent Application Publication
(10) Pub. No.: US 2003/0231642 A1
(43) Pub. Date: Dec. 18, 2003

(54) Data upgrade method for a switching device in two-layer network environment

(76) Inventor: Guiquan Mao, Shenzhen City (CN)

Correspondence Address: SCHNADER HARRISON SEGAL & LEWIS, LLP, 1600 MARKET STREET, SUITE 3600, PHILADELPHIA, PA, 19103

(21) Appl. No.: 10/405,426

(22) Filed: Apr. 2, 2003

(30) Foreign Application Priority Data
Apr. 2, 2002 (CN) 02103851.1

(51) Int. Cl. H04L 12/28

(52) U.S. Cl. 370/401; 370/395.21

(57) ABSTRACT

A data upgrade method for a switching device in a two-layer network environment that reduces or eliminates the need to configure IP addresses for switching devices. A switching device sends a register request message to a managing device and the managing device executes a register operation to the message. After the register operation is finished successfully, the switching device shakes hands with the managing device. During the handshaking, the managing device sends a data description frame of the data to be upgraded to the switching device and the switching device determines whether to execute a data upgrade operation after receiving the message. If yes, the switching device sends a data description frame response message allowing data upgrade. The managing device receives the data description frame response message and the data to be upgraded is downloaded to the switching device.

### FIELD OF THE INVENTION

The present invention relates to a data upgrade method for a network device, particularly to a data upgrade method for a switching device in a two-layer network environment.

### BACKGROUND OF THE INVENTION

With the rapid development of Local Area Networks (LANs), more and more network switching devices (such as Ethernet switches) are used. Because the network switching devices are distributed at different locations, data upgrade tasks for the network switching devices have to be done on site respectively, which results in high maintenance costs. To solve said problem, data upgrade tasks (such as software upgrades) for network switching devices are typically done through File Transfer Protocol (FTP) in current LAN environments. FTP includes two parts: Client FTP and Server FTP. Switching devices serve as clients, and managing devices serve as servers. Switching devices acquire data from connected managing devices and store the data to implement data upgrades.

FTP is implemented on the basis of Transfer Control Protocol or Internet Protocol (TCP/IP) and it employs two TCP links to transfer a file. Usually, a control link is opened in Client/Server method. A data link is created whenever a file is to be transferred, and then the upgrade data is downloaded from the managing device to the switching device by command/response cycles between the two devices. Because the FTP operates on the basis of TCP/IP, which works on the third layer in a network, IP addresses should be configured for the switching devices, in order to implement a data upgrade for the switching devices through FTP. So, if an IP address is configured for each switching device, IP address resources will be greatly wasted. Accordingly, there is a need for a data upgrade method for a switching device in a two-layer network environment that saves IP address resources.

### SUMMARY OF THE INVENTION

Embodiments of the present invention included a data upgrade method for a switching device in a two-layer network environment wherein:

(1) a switching device sends a register request message to a managing device, the managing device executes a register operation on the message. After the register operation is finished successfully, the switching device shakes hands with the managing device according to the regular handshake message sent from the switching device to the managing device and the handshake response message sent from the managing device to the switching according to the handshake message;

(2) the managing device sends a data description frame of the data to be upgraded to the switching device, and the switching device determines whether to execute a data upgrade operation after receiving the message; If not, the switching device responds by communicating a data description frame response message refusing the upgrade to the managing device; otherwise the switching device sends a data description frame response message allowing data upgrade;

(3) the managing device receives the data description frame response message and determines whether the switching device permits the upgrade; if yes, the data to be upgraded is downloaded to the switching device.

The data description frame of step (2) contains the length of data to be loaded and the serial number of the current data block

In step (2), when the switching device determines it should permit a data upgrade, it determines the size of a data block to be loaded in each upgrade cycle and then inserts a parameter representing the size of the data block in the data description frame response message before it sends the data description frame response to the managing device.

The data download process to the switching device in step (2) comprises the following steps:

(41) the managing device sends a data frame message to the switching device; the switching device receives and stores the data frame message and responds by communicating a data frame response message; the switching device may insert a time value in the data frame response message to instruct the managing device to pause sending subsequent data frames after receiving a data block; then the switching device writes the data received into the device load area and sends a block ending response message to the managing device;

(42) the managing device continues to send the next data frame message after receiving the block ending response message, after finishing receiving the last frame of the last data block, the switching device writes the data received into the device load area and responds by communicating a load ending message to the managing device; the managing device receives the load ending message and responds by communicating a load ending response message to the switching device to end the data upgrade process.

According to embodiments of the invention, the managing device and the switching device exchange information through messages with a specific format (Internet Group Management Protocol, IGMP), for example; the message may comprise an Ethernet heading with an 802.1Q label, a public message heading, and managing messages.

A public message heading may comprise the following fields:

version number, which is used to indicate the version of the current management protocol;

C, which is used to indicate whether the current message is a response message or a command message;

type, which is used to differentiate integrated management from a two-layer multicast group control message;

F, which is used to identify whether the frame serial number is effective;

R, which is used to identify whether the check sum is effective;

B, which is used to identify whether the feedback word is effective;

the frame serial number, which is used to indicate a message serial number according to each network switching device;

check sum, which is used to check message data;

length of message, which is used to identify the length of the message;

feedback word, which is used to indicate response the untouched feedback data by message;

media access control (MAC) for the switching device (LAN Switch): which is used to identify managing MAC addresses of the switching device;

the first transmitting port number, and the second transmitting port number, the third transmitting port number, the fourth transmitting port number, are respectively used to record the inlet port number after messages are transmitted by the switching device.

A managing message comprises:

a home command word, which is used to act as home command word of managing message;

a sub command word, which is used to act as sub command word of managing message;

a length of content, which is used to record the length of the content of the managing message;

a content of the managing message, which is used to record a parameter and data carried in the managing message.

In a two-layer network environment according to the present invention, first the switching device is registered in the managing device, after the register operation is finished successfully, the switching device shakes hands with the managing device according to the regular handshake message sent from the switching device to the managing device and the handshake response message sent from the managing device to the switching device according to the handshake message, during the handshake operation, the data upgrade from the managing device to the switching device is implemented. Therefore, compared to conventional data upgrade methods for networks having a switching device, an advantage of the present invention is that it is unnecessary to configure IP addresses for the switching devices, thus a data upgrade for network switching devices is realized while saving precious IP address resource in network.

### BRIEF DESCRIPTION OF THE DRAWING

FIG. 1 is the flow chart of an embodiment of a method according to the present invention.

### DETAILED DESCRIPTION OF THE INVENTION

The present invention will be described in further detail according to the following drawing and embodiment:

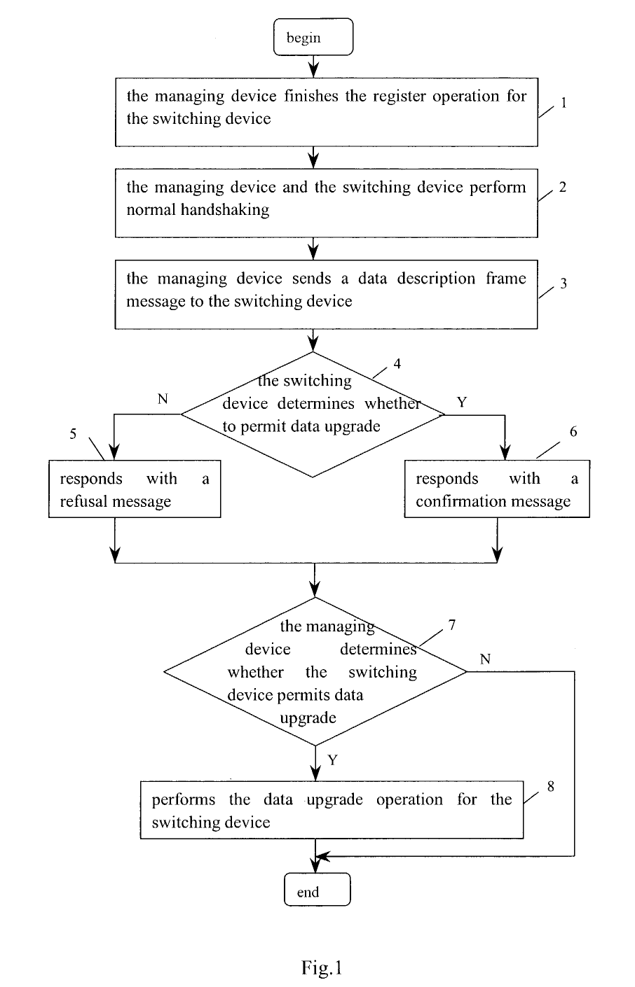

FIG. 1 is a flow chart of an embodiment of a method according to the present invention. According to the embodiment of FIG. 1, a data upgrade for switching devices in a two-layer network environment is shown. The embodiment of FIG. 1 works on Client/Server mode, i.e., the managing device serves as Server, while the switching device serves as Client. Therefore, the Server software for a data upgrade operates on the managing device, and the Client software operates on the switching device (such as a network switch). To facilitate the data upgrade from the managing device to the switching device by exchanging messages, the present invention provides a specific message format, which may comprise three parts for example: an Ethernet heading with an 802.1Q label, a pubic message heading, and managing messages. The content of the public message header and the managing messages will be described as followings:

The public message ca be carried behind the Ethernet header, the message may include one or more of the items in the follows table:

| | | | | | | | | | | | | | | | | | | | | | | |
|---|---|---|---|---|---|---|---|---|---|---|---|---|---|---|---|---|---|---|---|---|---|---|
| 31 | 30 | 29 | 28 | 27 | 26 | 25 | 24 | 23 | 22 | 21 | 20 | 19 | 18 | 17 | 16 | 15 | 14 | 13 | 12 | 11 | 10 | 9 8 7 6 5 4 3 1 0 |

| | | | | | | | | |
|---|---|---|---|---|---|---|---|---|
| 0 | Version | C | type | F | R | B | r reserved | frame serial number |

| | | |
|---|---|---|
| 1 | check sum | length of message |
| 2 | feedback word | MAC for switching device |

| 3 | MAC for switching device | | | |
|---|---|---|---|---|
| 4 | the first transmitting | the second transmitting | the third transmitting | the fourth |
| | port number | port number | port number | transmitting |
| | | | | port number |

| | |
|---|---|
| 5 | reserved |

The version number may occupy 4 bits, and is used to indicate the version of the current managing protocol.

The C field, may occupy1 bit, and is used to indicate whether the current message is a response message or a command message; for example, 0—represents command (or request), 1—represents response (or responding);

The type field may occupy 3 bits, and is used to differentiate between integrated management and two-layered multicast group control messages; for example, 000 may represent integrated management of the switching devices, 001 may represent multicast transmission for the switching devices.

The F field may occupy I bit and identifies whether the frame serial number, is effective; for example, the frame serial number is used when F=1.

The R field may occupy1 bit and is used to identify whether the check sum is effective for example, the check sum is not used when R=0; and the check sum is used when R=1.

The B field may occupy 1 bit and identifies whether the feedback word is effective; for example, the feedback word is not used when B=0; and the feedback word is used when B=1.

The frame serial number field may occupy 16 bits and is used to identify a message serial number according to each network switching device.

The length of the check sum may occupy 16 bits and is used to check message data. The calculating method may be similar to IP and UDP, and the R field determines whether it is effective.

The length of message field may occupy 16 bits and is used to identify length of the message.

The feedback word field may occupy 16 bits, and is used to indicate response the untouched.

The media access control (MAC) for a switching device field, is used to identify a managing MAC address of the switching device.

The first transmitting port number, the second transmitting port number, the third transmitting port number, and the fourth transmitting port number, are respectively used to record the inlet port number after the messages are transmitted by the switching devices. The physical positions of the switching devices can be determined by the fields. The effective range of port numbers is related to the port amount of some switching device. If the port amount of a switching device is PORT_NUM, when the switching device transmits the IGMP message to a switching device of a next layer, the range of transmitting port numbers is between 0 and PORT_NUM-1.

The reservation field may occupy: 4 byte and, is used to expand the function of messages. For example, if a cascade connection layer of the switching device is more than five, the field can be used to define the transmitting port number.

The managing message, which is carried under the public message in practical applications, comprises one or more of the following fields:

| | | | |
|---|---|---|---|
| home | sub command | length of content | content of the |
| command word | word | | managing message |

The home command word may occupy: 1 bit, and is used to act as a home command word of the managing message.

The sub command word may occupy: 1 bit, and is used to act as a sub command word of the managing message.

The length of content field may occupy: 2 bits, and is used to record the length of content of the managing message.

The content of the managing message is used to record a parameter and the data carried in the managing message. The exact format and size may change according to the application, and the length can be determined by the length of content field. Usually, with the limitation of length of Ethernet communications, the field is no more than 1468 bytes: from 0 to 1468 bytes.

As seen from above, implementing the present invention according to FIG. 1 comprises two processes: the first is the register and handshake with a switching device, through which a data upgrade channel is established between a managing device and a switching device; the second is the process of a data upgrade which is finished by handshaking between the managing device and the switching device. The steps are the following:

First in step 1, the switching device broadcasts a register request message including an address identification of a present switching device on the port connecting the managing device. The managing device executes a register operation after receiving the register request message, and sends a register response message to the switching device that sent the register request message. The switching device sends regular handshake messages to the managing device in step 2 after receiving a response message indicating a successful register. The managing device sends handshake response messages to the switching device after receiving the handshake messages. The switching device executes a normal handshake after receiving the handshake response messages. During the handshake operation, the managing device sends a data description frame message of upgrade data to the switching device in step 3, and said data description frame message includes the length of the data to be loaded by the switching device and the serial number length of the current data block to be loaded. The switching device receives the data description frame message and determines whether to permit a data upgrade in step 4. The switching device responds by communicating either a data frame response message refusing upgrade to the managing device in step 5, or determines the size of each block to be loaded during the upgrade cycle in step 6, then inserts the size parameter in the data description frame response message, and sends the data description frame response message to the managing device to confirm the data upgrade. The managing device receives the data description frame message, and determines whether the switching device permits the data upgrade in step 7. If yes, the managing device executes the data upgrade operation in step 8, i.e., downloads the upgrade data to the switching device; otherwise end.

The download of upgrade data to the switching device in step 8 can be implemented through the following steps:

The managing device sends a data frame message to the switching device. The switching device receives and stores the data frame message and responds by communicating a data frame response message. The switching device may insert a time value in the data frame response message to instruct the managing device to pause sending the subsequent data frames after receiving a data block. The switching device then writes the data received into the device load area and sends a block ending response message to the managing device.

The managing device continues to send the next data frame message after receiving the block ending response message. After finishing receiving the last frame of the last data block, the switching device writes the data received into the device load area and responds by communicating a load ending message to the managing device. The managing device receives the load ending message and responds by sending a load ending response message to the switching device to end the data upgrade process.

The data upgrade operation comprises the data upgrade processing procedure on the managing device and the upgrade data processing procedure on the switching device. The two procedures cooperate with each other. Since the actual software upgrade processes does not have a strict requirement for upgrade speed but does have a reliability requirement, it is preferred to execute software upgrades on mutual control mode, i.e., each time the managing device sends a data frame, it activates a timer to wait for the response from the switching device. If the managing device receives a response from the switching device for the previous frame in the specified time, the managing device begins to send the next frame. If the managing device doesn't receive any response or receives a check error response, it resends the previous frame. If the number of repetitions exceeds specified times, an alarm is sent to the background.

Because in practice the memory size varies in different switching devices and the acceptable data volume simultaneously depends on the different switching devices, the switching device detects the system memory size first when it receives the data description frame message from the managing device, and requests to allocate an appropriate load memory in the case that normal operation of the system is not affected, and then sends the size of each data block equaling the memory size to the managing device through the data description response frame message.

In actual data upgrade cases, the upgrade message may be initiated from the managing device or the switching device. In order to ensure the reliability of a data upgrade, the initiator shall launch a timer. If the initiator does not receive a response from the opposite party, it will resend the previous message. If the initiator does not receive any response over specified times, such as 3 seconds, it will exit the load process. Therefore, in order to control the upgrade process better, in one embodiment, 5 timers (T0-T4) are configured, wherein T0 is set to 3 seconds; T1, 3 seconds; T2, 6 seconds; T3, 6 seconds; and T4, 3 seconds.

According to the timers, first, the managing device sends a data description frame to the switching device and to activate timer T0, and then waits for the response from the switching device. If it receives a response from the switching device in 3 seconds, it will take out the data block size information from the response message and calculate the number of frames in each data block and the total number of data blocks. Then, the managing device launches the data load process to transfer data to the switching device. If the managing device doesn't receive any data description frame response message from the switching device in 3 seconds, it will resend the data description frame. If the repetition exceeds 2, the managing device will exit the load process and sends an alarm to the background.

In order to facilitate the data interaction during the transmission of data frames, each data frame carries the number of current data blocks and the serial number of the current data frame. The data transmission process comprises the following periods:

1. For a common data frame, the managing device will activated a 3-second timer T1 after sending a frame. If the managing device receives a correct response from the switching device in 3 seconds, it continues to send the next frame. If the managing device doesn't receive any response or receives a “check error” response, it will resend the previous frame. If the repetition exceeds twice, the managing device will exit the load process and send an alarm to the background.

2. For the last frame of a data block, the managing device will activate a 3-second timer T1 after sending the frame, and wait for the response from the last frame. If the managing device doesn't receive any response or receives a check error message from the previous frame in 3 seconds, it will resend the previous frame. If the repetition exceeds twice, the managing device will exit the load process and send an alarm to the background. If the managing device receives a response, it takes out the wait time of timer T2 from the response message and activates timer T2 to wait for the block ending message. If the managing device doesn't receive the block ending message in the wait time of timer T2, it will exit the load process and send an alarm to the background. If it receives a block ending message in the wait time of timer T2 it will continue to send the next data block.

3. For the last frame of the last data block, the managing device will activate a 3-second timer T1 after sending the frame and wait for the response from the last frame. If the managing device doesn't receive any response or receives a check error message from the last frame in 3 seconds, it will resend the last frame. If the repetition exceeds twice, the managing device will exit the load process and send an alarm to the background. If the managing device receives a response, it takes out the wait time of timer T2 from the response message and activates timer T2 to wait for the load ending message. If the managing device doesn't receive the load ending message in the wait time of timer T2, it will exit the load process and send an alarm to the background. However, if it receives a load ending message in the wait time of timer T2, it will respond to the switching device with a load ending response message, display the load result, and end the load process.

At the switching device side, the switching device receives the data description frame from the managing device, takes out the data, and verifies its validity. If the data is invalid, the switching device responds to the managing device with an error message at once, and exits the load process. If the data is valid, the switching device detects the system memory size, requests an appropriate load memory size, inserts the load memory size information as the size for each data block in the data description response frame, and sends the frame back to the managing device and activates timer T3. If the switching device doesn't receive any data information from the managing device in T3, it will exit the load process.

When the switching device receives a common data frame, it stops timer T3 and determines whether the block number and serial number of data frame are the expected values. If the block number is correct but the frame number is identical to the previous value, it indicates that the managing did not receive the previous response and thus resent the previous frame. In this case, the switching device needs only to resend the previous data frame response message and activate timer T3. If either the block number or frame number is incorrect, the switching device will send a frame error response message and activate timer T3. If both the block number and the frame number are correct, the switching device may respond as follows:

1. If the data frame received is the last frame of the last block, the switching device verifies the correctness of the data according to the check sum. If there is an error, it responds with an error data frame response directly and activates timer T3. If correct, it responds with a correct data response and fills the wait time in the response message. The data is then copied into the load cache and the last data block is written into the load area of the device. If the write operation fails, the switching device sends a load ending message with a failing flag and exits the load process. If the write operation succeeds, the switching device sends a load ending message with a successful flag to the managing device and activates timer T4. If it receives a load ending response message within the time of timer T4, it will stop timer T4 and exit the load process. If it doesn't receive the response message within the time of timer T4, it will resend the load ending message. If the repetition exceeds twice, the switching device will exit the load process.

2. When the switching device receives the last data frame of a data block (except for the last data block), first, the switching device verifies the correctness of the data according to the check sum. If there is an error, it responds with an error data frame response directly and activates timer T3. If correct, it fills the wait time and responds with a correct data frame response message, copies the data into the cache and the data block into the device load area, respectively. If the write operation fails, the switching message sends a data block ending message with a failing flag and exits the load process. If the write operation succeeds, the switching device sends a data block ending message with a success flag and activates timer T4. If the switching device receives a new data frame sent from the managing device in the wait time of timer T4, it stops timer T4 and processes the next data block. Otherwise, it will resend the data block ending message and activate timer T4. If the repetition exceeds twice, the switching device will exit the load process.

3. When the switching device receives a common data frame, it verifies the correctness of data according to the check sum. If correct, it loads the data into the cache and respond to the managing device with a correct data frame response and activates timer T3. If there is an error, it responds with an error data frame response and activates timer T3. If the switching device doesn't receive any data from the managing device in the wait time of timer T3, it indicates that communication has been interrupted, exits the load process, and executes the register again.

In the embodiment of FIG. 1, the data description frame message, data description frame response message, data frame message, data frame response message, ending response messages, load ending message, and load ending response message for the data upgrade process are encapsulated in managing messages of IGMP messages. The detailed structure of the messages comprises:

1. data description frame message:

data length (ulDataLen): describes the total length of the upgrade data;

number of frames (usFrameNum): describes the total number of frames of the upgrade data;

load serial number (usLoadSerial): describes the serial number of the load process;

load command word (ucLoadCmd): describes the home command word, for example, 0—upgrade application program; 1—upgrade boot program;

load parameters (ucParam50): describes the attached parameters;

In addition, the embodiment, frame-by-frame mode is used for CRC check for the data, and each data frame carries a 16-bit CRC check-bit. Load parameters can carry different parameters according to different home command words. For example, the command word of the upgrade program may carry a name of the program and type, etc.

2. data description frame response message for data upgrade:

data description result (ucDataDescResult): describes the frame result, for example, 0—enable load; 1—disable load;

block size (usBlockSize): describes the size of the data block to be loaded;

load serial number (usLoadSerial): describes the serial number of the load process;

3. data frame message for date upgrade:

load serial number (usLoadSerial): describes the serial number of load process;

block number (ucBlockNo): describes the number of the load data block;

frame number (usFrameNo): describes the number of the data frame;

CRC (usCRC): describes the CRC for the current data frame, frame-by-frame mode is used to check only the load data;

frame length (usLen): describes the length of the current data frame;

data (ucData1024): describes the load data content;

4. data frame response message for data upgrade load serial number (usloadSerial): describes the serial number of the load process;

block number (ucBlockNo): describes the number of the load data block;

frame number (usFrameNo): describes the number of the response frame;

load result (ucLoadResult): describes the data frame load result for the upgrade data, for example, 0—correct; 1—error, etc;

wait time (ucWaitTime): describes the time interval between data frames. For example, between common data frames, ucWaitTime=0, the managing device may send the next data frame at once. When the block ends, the wait time has to be longer due to the delay time resulting from writing block data into the device load area. In the wait time, if the managing device receives a block ending message, it will send the next data block. Otherwise, it will exit the load process and send an alarm.

5. block ending message for data upgrade:

load serial number(usLoadSerial): describes the serial number of the load process;

block number (ucBlockNo): describes the data block number;

load result (ucLoadResult): describes the data frame load result, for example, 0—correct; 1—error;

6. load ending message for data upgrade:

load serial number (usLoadSerial): describes the serial number of the load process;

load result (ucLoadResult): describes load result of the data block, for example, 0—correct; 1—error, etc;

7. load end response message for data upgrade load serial number (usLoadSerial): describes the serial number of the load process;

What is claimed is:

1. A data upgrade method for a switching device in a two-layer network environment, comprising:
(A) the switching device sending a register request message to a managing device, the managing device executing a register operation upon the message, after completion of the register operation performing a handshake between the switching device and the managing device;
(B) the managing device sending a data description frame message to be upgraded to the switching device, and the switching device determining whether to execute a data upgrade operation, if not, the switching device responding with a data description frame response message refuising to upgrade to the managing device; otherwise the switching device sending a data description frame response message allowing data upgrade;
(C) the managing device receiving the data description frame message and determining whether the switching device permits to an upgrade; if so, the data to be upgraded being downloaded to the switching device.

2. The data upgrade method of claim 1, wherein said data description frame of step (B) comprises a message of a length of data to be loaded and a serial number of a current data block.

3. The data upgrade method of claim 2, wherein in step (B), when the switching device decides to upgrade data, determining a size of data block to be loaded in each upgrade cycle and then inserting a parameter equaling to the data block in size in the data description frame message before sending the data description frame message to the managing device.

4. The data upgrade method of claim 3, wherein said data download process to the switching device in step (B) further comprises the following steps:
(D) the managing device sending the data frame message to the switching device; the switching device receiving and storing the data frame message and responding with a data frame response message, the switching device inserting a time value in the data frame response message to instruct the managing device to pause sending the subsequent data frames after receiving a data block; then the switching device writing the data received into a device load area and sending a block ending response message to the managing device;
(E) the managing device continuing to send a next data frame message after receiving the block ending response message, after finishing receiving a last frame of a last data block, the switching device writing data received into the device load area and responding with a load ending message to the managing device; the managing device receiving the load ending message and responding with a load ending response message to the switching device to end the data upgrade process.

5. The data upgrade method of claim 4, wherein said steps (D) and (E) further comprise a data upgrade processing procedure on the managing device and a data upgrade processing procedure on the switching device.

6. The data upgrade method of claim 5, wherein said data upgrade processing procedure on the managing device comprises:
(F) the managing device sending the data description frame message to the switching device, and if the managing device receives a response from the switching device within a specified time, proceeding to step (G), otherwise resending the data description frame message, and if the resending time exceeds a specified time, ending the upgrade operation;
(G) the managing device calculating the number of frames for each data block and a total number of data blocks according to the data block size sent each time and activating the data load process;
(H) after sending a data frame message, if the managing device receives a correct response from the switching device in the specified time, continuing to send a next data frame message, otherwise terminating the upgrade operation;
(I) after sending a last data frame of a data block, if the managing device receives a correct response from the switching device in a specified time, the managing device continuing to send the next data block; otherwise resending the data frame message and if the resending time exceeds a specified time, the managing device terminating the upgrade operation;
(J) after sending the last data frame message for the last data block, if the managing device receives a correct response for the data frame and the load ending response message, the managing device notifying the switching device of the end of data load and ending the upgrade operation; otherwise the managing device resending the data frame, if the resending time exceeds a specified time, the managing device terminating the upgrade operation, and if the managing device doesn't receive a load ending response message, the managing device terminating the upgrade operation.

7. The data upgrade method of claim 6, wherein said data upgrade process on the switching device further comprises.
(K) after the switching device receives the data description frame message from the managing device, if the data is valid, the switching device allocating a memory space and responding with the size of the memory space as the size of the data blocks to be loaded to the managing device;
(L) when receiving a common data frame message, if the data is in error, the switching device responding to the managing device with a data frame error message; if the data is valid, the switching device copying the data to a cache and responding to the managing device with a correct data frame response message; if the switching device doesn't receive any data from the managing device in a specified time, it indicating an interception in the communication process, exiting the load process, and then beginning the register process;
(M) when receiving the last data frame for the last data block, the switching device verifying a check sum of the data, if the data is in error, the switching device responding to the managing device with an error data frame response message, if the data is correct, the switching device responding to the managing device with a data frame correct response message and then copying the data into the cache and writing data of the last block into the device load area, if the write operation fails, the switching device sending a load ending message with a failure flag to the managing device and exiting the load process; if the write operation succeeds, the switching device responding to a load ending message with a success flag to the managing device, if receiving a load ending response message in specified time, the switching device exiting the load process; otherwise the switching device resending the load ending message, and if a time of resending the load ending message exceeds a specified value, the switching device exiting the load process;
(N) when the switching device receives the last data frame of a data block except the last data block, if the data is in error, the switching device responding to the managing device with an error data frame response message, otherwise the switching device responding to the managing device with a correct data frame response message and then copying the data into the device load area, if the write operation fails, the switching message sending a data block ending message with an error flag and exiting the load process, if the write operation succeeds, the switching device responding to a data block ending message with a success flag to the managing device, if receiving a new data frame sent from the managing device in a specified time, the switching device processing the next data block; otherwise the switching device resending the data block ending message, if the amount of time to resend the data block ending message exceeds a specified value, the switching device exiting the load process.

8. The data upgrade method of claim 1, wherein the managing device and the switching device exchange information through messages with a format comprising an Ethernet header, a public message header, and managing messages.

9. The data upgrade method of claim 8, wherein said public message header comprises one or more fields selected from the following group: version number, indicating the version of current management protocol;
C, indicating whether current message is a response message or a demand message; type, differentiating integrated management from two-layer multicast group control message;
F, identifying whether the frame serial number is effective;
R, identifying whether the check sum is effective;
B, identifying whether the feedback word is effective; the frame serial number, indicating message serial number according to each network switching device;
check sum, checking message data;
length of message, identifying the length of the message;
feedback word, indicating response the untouched feedback data by message;
media access control (MAC) for switching device (LAN Switch): identifying the managing MAC addresses of the switching device; and
the first transmitting port number, the second transmitting port number, the third transmitting port number, the fourth transmitting port number, respectively recording the inlet port number after messages are transmitted by the switching device.

10. The data upgrade method of claim 8, wherein said managing message comprises one or more of the following:
a home command word, used as home command word of the managing message; sub-command word, used as sub command word of the managing message; length of content, recording the length of content of the managing message; and content of the managing message, recording the parameter and data carried in the managing message.

11. The data upgrade method of claim 8, wherein one or more of the following are encapsulated in managing messages for IGMP messages:
data description frame message, data description frame response message, data frame message, data frame response message, ending message, load ending message, and load ending response message for the data upgrade process.
